(19) United States
(12) Patent Application Publication
(10) Pub. No.: US 2019/0140273 A1
(43) Pub. Date: May 9, 2019

(54) CATHODE ACTIVE MATERIAL FOR LITHIUM SECONDARY BATTERY, MANUFACTURING METHOD THEREOF, AND LITHIUM SECONDARY BATTERY INCLUDING THE SAME

(71) Applicant: KOREA BASIC SCIENCE INSTITUTE, Yuseong-gu (KR)

(72) Inventors: MING YOUNG SONG, DAEJEON (KR); HAE JIN KIM, DAEJEON (KR); WON GI HONG, DAEJEON (KR); JIN BAE LEE, DAEJEON (KR); JONG GUK KIM, DAEJEON (KR)

(21) Appl. No.: 16/182,787

(22) Filed: Nov. 7, 2018

(30) Foreign Application Priority Data
Nov. 8, 2017 (KR) 10-2017-0147932

(51) Int. Cl. H01M 4/505; H01M 10/0525

(52) U.S. Cl. CPC H01M 4/505; H01M 2004/028; H01M 10/0525

(57) ABSTRACT

A manufacturing method of a cathode active material for lithium secondary battery, including: preparing a first solution by mixing a metal oxide and a solvent; preparing a metal-mixed solution by adding an acidic solution to the first solution and then applying ultrasonic waves to the mixture; centrifuging the metal-mixed solution; preparing a second solution by mixing a supernatant of the centrifuged metal-mixed solution, a reductant, and a solvent and then applying ultrasonic waves to the mixture; obtaining powder by filtering and then drying the second solution; forming mesoporous spherical nanoparticles by mixing the powder, a metal, a lithium precursor, and a solvent, applying ultrasonic waves to the mixture and then drying the mixture; and performing a heat treatment to the spherical nanoparticles, and a cathode active material for a lithium secondary battery obtained by the manufacturing method. The cathode active material for lithium secondary battery is mesoporous spherical nanoparticles.

### CROSS-REFERENCE TO RELATED APPLICATIONS

This application claims the benefit under 35 U.S.C. 119(a) of Korean Patent Application No. 10-2017-0147932 filed on Nov. 8, 2017 in the Korean Intellectual Property Office, the entire disclosure of which is incorporated herein by reference for all purposes.

### BACKGROUND

### Field

The present disclosure relates to a cathode active material for lithium secondary battery and more particularly, to a cathode active material for lithium secondary battery which has structural stability by improving the process and controlling the metal composition and particle shape of the cathode active material for lithium secondary battery, a manufacturing method thereof, and a lithium secondary battery including the same.

### Description of Related Art

In recent years, the miniaturization of electronic devices has reached mobile phones, notebook computers (PCs), etc., and as applicable fields have been extended, research and development of storage technology have been actively carried out. Further, the stability as well as high capacity and high power still remains as a big problem to be solved. In this respect, the development of a chargeable and dischargeable lithium secondary battery has attracted increasing attention.

A lithium secondary battery is composed of a cathode, an anode, and an electrolyte. Particularly, the cathode is the highest in proportion and importance. A cathode active material as a material constituting the cathode should have a high energy density during charges and discharges and should not be destroyed by intercalation and deintercalation of reversible lithium ions. Further, the cathode active material needs to have a high electrical conductivity and a high chemical stability to an organic solvent used as the electrolyte.

Lithium composite metal compounds have been used as a cathode active material for lithium secondary battery, and for example, composite metal oxides such as LiCoO₂, LiMn₂O₄, LiNiO₂, LiNi₁₋ₓCoₓO₂(0<x<1), LiMnO₂ have been researched.

LiCoO₂ is the most widely used cathode active material for lithium secondary battery. However, this compound is expensive and disadvantageous in terms of stability. Therefore, in recent years, a lot of studies are being carried out on other active materials.

Particularly, a lithium manganese composite oxide Li₁₊ₓMn₂₋ₓO₄ (0≤x≤0.12) having a spinel structure is cheaper and has high stability in use and environmentally friendly properties, and, thus, it is one of the most actively studied materials. However, as for Li₁₊ₓMn₂₋ₓO₄ (0≤x≤0.12), manganese ions may be eluted from a LiMn₂O₄ crystal structure into an electrolyte as charge and discharge proceed.

The manganese ions eluted into the electrolyte may be precipitated on the surface of an anode and thus obstruct intercalation or deintercalation of lithium ions into or from an anode material and cause an increase in internal resistance. As a result, repeated charges and discharges may cause a decrease in discharge capacity. Further, if the manganese ions are eluted from LiMn₂O₄ crystals constituting a cathode into the electrolyte, the cathode and the electrolyte may degenerate and deteriorate. The degeneration and deterioration of each material constituting the battery may cause degradation of cycle characteristics.

As one of the methods for suppressing degradation of performance of a manganese-based lithium secondary battery, a method of substituting some of Mn atoms with elements such as Co, Ni, Cr, Fe, etc. and stabilizing a crystal structure of a lithium manganese composite oxide has been suggested. This method is conceived to strengthen the LiMn₂O₄ crystal structure by substituting a part of Mn with Co, Ni, Cr, Fe, etc. and decreasing a lattice constant of LiMn₂O₄ and thus to suppress a decrease in discharge capacity caused by destruction of the crystal structure.

In general, a cathode active material for lithium secondary battery is manufactured at a high temperature of 700° C. or more through solid-state reaction. However, if a cathode active material is manufactured through the solid-state reaction, physical mixing and grinding are performed, which results in non-uniform mixing state. Therefore, mixing and grinding need to be performed several times, which causes a great increase in time required for manufacturing as well as an increase in manufacturing cost. Accordingly, wet-type manufacturing methods represented by sol-gel process and co-precipitation have been developed.

If a cathode active material is manufactured by co-precipitation, a pH of a co-precipitation solution, temperature, and stirring conditions need to be controlled. Conventionally, co-precipitation has been implemented mainly with a continuous stirred-tank reactor (CSTR). However, according to these methods, all the finally obtained metal hydroxides go through a predetermined co-precipitation and thus cannot have the optimum sphericity and degree of densification.

Further, in order to improve the safety of a lithium secondary battery, it is necessary to control the distribution of particles of less than 3 μm which have excellent electrochemical reactivity. However, according to the conventional method of manufacturing a metal hydroxide using the CSTR, it is difficult to implement the distribution of particles with high sphericity and degree of densification through co-precipitation.

Accordingly, there has been an urgent need for a manufacturing method of a cathode active material which can improve the performance of a lithium secondary battery by changing the composition of a lithium transition metal oxide or controlling a crystal structure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An object to be achieved by the present disclosure is to provide a method of manufacturing a cathode active material for lithium secondary battery more quickly and easily by using ultrasonic waves.

Another object to be achieved by the present disclosure is to provide a cathode active material for lithium secondary battery which has a high crystallinity and a maximized effective reaction area by controlling the metal composition and particle shape of a cathode active material for lithium secondary battery including mesoporous spherical nanoparticles.

According to an aspect of the present disclosure, there is provided a manufacturing method of a cathode active material for lithium secondary battery, including: preparing a first solution by mixing a metal oxide and a solvent; preparing a metal-mixed solution by adding an acidic solution to the first solution and then applying ultrasonic waves to the mixture; centrifuging the metal-mixed solution; preparing a second solution by mixing a supernatant of the centrifuged metal-mixed solution, a reductant, and a solvent and then applying ultrasonic waves to the mixture; obtaining powder by filtering and then drying the second solution; forming mesoporous spherical nanoparticles by mixing the powder, a metal, a lithium precursor, and a solvent, applying ultrasonic waves to the mixture and then drying the mixture; and performing a heat treatment to the spherical nanoparticles.

Preferably, in the preparing of the metal-mixed solution, the preparing of the second solution, and the forming of the mesoporous spherical nanoparticles, ultrasonic waves with a frequency in the range of from 5 kHz to 50 kHz are applied for 1 minute to 60 minutes.

Preferably, the preparing of the metal-mixed solution, the preparing of the second solution, and the forming of the mesoporous spherical nanoparticles are performed at a temperature in the range of from 10° C. to 40° C.

Preferably, the heat treatment is performed in the range of from 600° C. to 900° C.

The acidic solution may include at least one acid selected from the group consisting of sulfuric acid (H₂SO₄), hydrochloric acid (HCl), phosphoric acid (H₃PO₄), acetic acid (CH₃COOH), and nitric acid (HNO₃).

The metal oxide may include a metal oxide based on at least one metal selected from the group consisting of Li, B, C, Na, Mg, Al, Si, P, Ca, Sc, Ti, V, Cr, Mn, Fe, Co, Ni, Cu, Zn, Ga, Ge, As, Sr, Y, Zr, Nb, Mo, Sn, Ba, Hf, and La.

The solvent may include at least one solvent selected from the group consisting of ethanol, anhydrous ethanol, isopropyl alcohol, or combinations thereof.

The reductant may be manganese sulfate (MnSO₄) or manganese chloride (MnCl₂).

According to another aspect of the present disclosure, there is provided a cathode active material for lithium secondary battery which includes at least one compound selected from general formula (1) below and has a mesoporous spherical nanoparticle shape.

Li₁₊ₓMn_{2-y}M_{y}O₄ (1)

In general formula (1), M is at least one metal selected from the group consisting of Ni, Co, Mn, Al, V, Fe, P, and Cr, 0≤x≤0.1, and 0.3≤y≤0.7.

According to yet another aspect of the present disclosure, there is provided a lithium secondary battery including: the cathode active material for lithium secondary battery; an anode active material; and an electrolyte.

According to the present disclosure, a manufacturing method of a cathode active material for lithium secondary battery makes it possible to easily manufacture a cathode active material for lithium secondary battery through a simple process using ultrasonic waves and thus makes it possible to mass-produce the cathode active material for lithium secondary battery.

A cathode active material for lithium secondary battery including mesoporous spherical nanoparticles according to the present disclosure has a structural stability by controlling the metal composition and particle shape and decreasing a lattice constant to reduce elution of Mn³⁺ and has a high capacity and stable cycle characteristics caused by a high crystallinity and a maximized effective area.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is an EDS image of a cathode active material manufactured according to Example 1;

FIG. 2 is a TEM image of the cathode active material manufactured according to Example 1;

FIG. 3(a) illustrates a capacity depending on the charge or discharge of a battery including the cathode active material manufactured according to Example 1; and

FIG. 3(b) illustrates a capacity depending on the charge or discharge of a battery including a cathode active material manufactured according to Comparative Example 1.

### DETAILED DESCRIPTION OF THE PREFERRED EMBODIMENT

Hereinafter, the present disclosure will be described in more detail with reference to examples and the accompanying drawings.

A manufacturing method of a cathode active material for lithium secondary battery according to the present disclosure includes: preparing a first solution by mixing a metal oxide and a solvent; preparing a metal-mixed solution by adding an acidic solution to the first solution and then applying ultrasonic waves to the mixture; centrifuging the metal-mixed solution; preparing a second solution by mixing a supernatant of the centrifuged metal-mixed solution, a reductant, and a solvent and then applying ultrasonic waves to the mixture; obtaining powder by filtering and then drying the second solution; forming mesoporous spherical nanoparticles by mixing the powder, a metal, a lithium precursor, and a solvent, applying ultrasonic waves to the mixture and then drying the mixture; and performing a heat treatment to the spherical nanoparticles.

In the preparing of the metal-mixed solution, the metal-mixed solution is prepared by applying ultrasonic waves while adding the acidic solution to the first solution in an isothermal reactor.

The isothermal reactor refers to a reactor configured to maintain a reacting solution at a constant temperature during a synthesis reaction and maintains the reacting solution at a constant temperature during application of ultrasonic waves in the preparing of the cathode active material.

The addition of the acidic solution to the first solution results in maintaining a pH suitable for one-dimensional co-precipitation, and the centrifugation makes it possible to easily remove by-products generated during a synthesis reaction for manufacturing the cathode active material. Preferably, the centrifugation is performed at about 4000 rpm for 1 to 5 minutes. If the centrifugation is performed for less than 1 minute, the mixed solution cannot be centrifugated well. If the centrifugation is performed for more than 5 minutes, manufacturing lead time can be increased.

The cathode active material for lithium secondary battery manufactured by the above-described method is a mesoporous material formed as a physically laminated structure of single crystals. Its three-dimensional nanostructure shape results in maximizing a reaction area, i.e., an effective reaction area, with battery reactants such as lithium ions and an electrolyte. Further, the cathode active material for lithium secondary battery has a structural stability due to its mesoporous surface formed as a physically laminated structure.

Preferably, in the preparing of the metal-mixed solution, the preparing of the second solution, and the forming of the mesoporous spherical nanoparticles, ultrasonic waves with a frequency in the range of from 5 kHz to 50 kHz are applied for 1 minute to 60 minutes, but the present disclosure is not limited thereto. Further, the ultrasonic waves may have various frequencies and application times depending on the concentrations and manufacturing conditions of the metal-mixed solution and the second solution.

If the ultrasonic waves have a frequency of 5 kHz and an application time of less than 1 minute, the overall diameters of particles of the cathode active material for lithium secondary battery may be increased but the crystallinity and recovery rate may be decreased. If the ultrasonic waves have a frequency of 50 kHz and an application time of more than 60 minutes, the crystallinity and recovery rate of particles of the cathode active material for lithium secondary battery may be improved but the cathode active material may be formed into smaller particles or particles of the manufactured cathode active material for lithium secondary battery may be ground, and, thus, the active area may be sharply decreased.

Preferably, the preparing of the metal-mixed solution, the preparing of the second solution, and the forming of the mesoporous spherical nanoparticles are performed at a temperature in the range of from 10° C. to 40° C.

The above-described temperature range refers to a temperature of a reaction phase during application of ultrasonic waves. In order to suppress an increase in temperature of the reaction phase caused by ultrasonic energy, an ultrasonic pulse may be regulated at about 1-minute intervals.

If the temperature is maintained at less than 10° C., the amount of unreacted material may be increased. If the temperature is more than 40° C., a rapid reaction may occur, which may result in the generation of a cathode active material which has irregular shapes instead of a regular spherical nanoparticle shape.

The heat treatment of the present disclosure is performed to transform the mesoporous spherical nanoparticles generated during the above-described manufacturing process into nanoparticles with a high crystallinity through a phase change. Preferably, the heat treatment is performed in the range of from 600° C. to 900° C. Further, preferably, the heat treatment is performed for 1 to 3 hours.

If the heat treatment is performed at less than 600° C., a phase change may not be sufficient, and if the heat treatment is performed at more than 900° C., the aggregation of nanoparticles may occur. Further, if the heat treatment is performed for less than 1 hour, a uniform crystallinity may not be achieved, and if the heat treatment is performed for more than 3 hours, a phase separation of the nanoparticles may occur.

In the present disclosure, the acidic solution is used to remove by-products generated during a reaction. The acidic solution may include at least one acid selected from the group consisting of sulfuric acid (H₂SO₄), hydrochloric acid (HCl), phosphoric acid (H₃PO₄), acetic acid (CH₃COOH), and nitric acid (HNO₃) and preferably H₂SO₄, but is not limited thereto.

The metal oxide is a precursor including a metal constituting the cathode active material. The metal oxide may include a metal oxide based on at least one metal selected from the group consisting of Li, B, C, Na, Mg, Al, Si, P, Ca, Sc, Ti, V, Cr, Mn, Fe, Co, Ni, Cu, Zn, Ga, Ge, As, Sr, Y, Zr, Nb, Mo, Sn, Ba, Hf, and La.

In the present disclosure, any solvent capable of easily dissolving the above-described metal oxide can be used without particular limitation. The solvent may include at least one solvent selected from the group consisting of ethanol, anhydrous ethanol, isopropyl alcohol, or combinations thereof.

The reductant of the present disclosure forces the reduction of a manganese oxide (MnO₄) generated during the above-described manufacturing process, and, thus, single crystals of manganese oxide (MnO₂) are formed. The reductant may be manganese sulfate (MnSO₄) or manganese chloride (MnCl₂) and preferably manganese sulfate (MnSO₄), but is not limited thereto.

A cathode active material for lithium secondary battery according to the present disclosure includes at least one compound selected from general formula (1) below and has a mesoporous spherical nanoparticle shape.

The mesoporous spherical nanoparticle shape of the cathode active material for lithium secondary battery results in maximizing an effective reaction area with battery reactants such as lithium ions and an electrolyte. Due to its mesoporous surface formed as a physically laminated structure, a secondary battery employing the cathode active material for lithium secondary battery has a high energy density during charges and discharges and a high structural stability without being structurally destroyed by intercalation and deintercalation of reversible lithium ions.

Li₁₊ₓMn_{2-y}M_{y}O₄ (1)

In general formula (1), M is at least one metal selected from the group consisting of Ni, Co, Mn, Al, V, Fe, P, and Cr, 0≤x≤0.1, and 0.3≤y≤0.7.

The cathode active material for lithium secondary battery doped with dissimilar metals supplements a structural weakness of the existing lithium manganese composite metal compounds and reduces elution of Mn³⁺ from a crystal structure to increase the structural stability and improve the charge and discharge cycle characteristics and lifespan.

Preferably, the mesoporous spherical nanoparticles may have an average particle diameter of from 150 nm to 400 nm.

Rod-like single crystals constituting the mesoporous spherical nanoparticles may have a size of from 10 nm to 50 nm, and these single crystals are formed into a physically laminated structure, and, thus, spherical nanoparticles with a mesoporous surface are formed.

If the mesoporous spherical nanoparticles have an average particle diameter of less than 150 nm, the aggregation of the cathode active material may occur, which may cause a decrease in dispersibility of the cathode active material within the active material layer and an increase in resistance within the electrode. If the mesoporous spherical nanoparticles have an average particle diameter of more than 400 nm, the dispersibility of the cathode active material and the capacity may be decreased.

The spherical nanoparticles formed by laminating the single crystals are laminated to form mesoporous spherical clusters. The clusters may have an average particle diameter of from 1 μm to 3 μm.

A lithium secondary battery according to the present disclosure includes the cathode active material for lithium secondary battery, an anode active material, and an electrolyte.

Specifically, the lithium secondary battery may include a cathode composed of a cathode active material and a current collector, an anode composed of an anode active material and a current collector, and an electrolyte for conduction of lithium ions between the cathode and the anode.

The anode active material of the present disclosure may employ any compound suitable for reversible intercalation and deintercalation of lithium without particular limitation. The anode active material may include one or more members selected from the group consisting of carbonaceous materials such as synthetic graphite, natural graphite, graphitized carbon fibers, amorphous carbon, etc., metallic compounds which can be alloyed with lithium (Li) such as silicon (Si), aluminum (Al), tin (Sn), lead (Pb), zinc (Zn), bismuth (Bi), indium (In), manganese (Mn), gallium (Ga), cadmium (Cd), silicon alloys, tin alloys, or aluminum alloys, and composites containing the metallic compounds and the carbonaceous materials.

The electrolyte may include one or more members selected from the group consisting of organic liquid electrolytes, inorganic liquid electrolytes, solid-type polymer electrolytes, gel-type polymer electrolytes, inorganic solid electrolytes, and molten-type inorganic electrolytes which can be used in manufacturing a lithium secondary battery, but is not limited thereto.

The electrolyte may include a binder, a lithium salt, and an organic solvent.

The binder may include one or more members selected from the group consisting of polyvinyl difluoride, polyethylene, polypropylene, etc., but is not limited thereto.

The organic solvent may employ any solvent capable of functioning as a medium through which ions involved in chemical reaction of a battery can move without particular limitation. Specifically, the organic solvent may include one or more organic members selected from the group consisting of N-methyl-2-pyrrolidinone, propylene carbonate, ethylene carbonate, butylene carbonate, dimethyl carbonate, diethyl carbonate, γ-butyrolactone, 1,2-dimethoxyethane, tetrahydroxy Franc, 2-methyltetrahydrofuran, dimethyl sulfoxide, 1,3-dioxolane, formamide, dimethylformamide, dioxolane, acetonitrile, nitromethane, methyl formate, methyl acetate, phosphoric acid triesters, trimethoxymethane, dioxolane derivatives, sulfolane, methylsulfolane, 1,3-dimethyl-2-imidazolidinone, propylene carbonate derivatives, tetrahydrofuran derivatives, ethers, methyl propionate, and ethyl propionate.

The lithium salt may employ any compound capable of supplying lithium ions to be used in a secondary battery without particular limitation. The lithium salt may include one or more members selected from the group consisting of LiPF₆, LiBF₄, LiSbF₆, LiAsF₆, LiC₄F₉SO₃, LiClO₄, LiAlO₂, LiAlCl₄, LiCl, LiI, LiB(C₂O₄)₂, and LiTFSI.

Hereinafter, the present disclosure will be described based on more detailed examples.

### [Example] Preparation of Cathode Active Material for Lithium Secondary Battery

### Example 1

A first solution was prepared by mixing 0.1 M barium manganate (BaMnO₄) with 100 ml of distilled water. Then, 2.8 ml of 4 M sulfuric acid(H₂SO₄) was slowly added to the first solution, ultrasonic waves with 750 W power, 50% amplitude, and 20 kHz frequency were applied for 5 minutes, and a thus prepared metal-mixed solution was centrifuged. A supernatant of the centrifuged metal-mixed solution, 400 ml of distilled water, and manganese sulfate (MnSO₄) were mixed and kept in a stationary state at 1-minute intervals to suppress a temperature increase at 750 W power, 50% amplitude, and 20 kHz frequency, and the mixture was applied with ultrasonic waves for 30 minutes and stirred at room temperature for 3 hours.

Then, the mixture was filtered using distilled water and ethanol and repeatedly washed and dried in a 100° C. oven for 12 hours to obtain manganese dioxide (MnO₂) powder.

Ni(NO₃)₂·6H₂O, LiOH and manganese dioxide (MnO₂) were mixed with 10 ml of ethanol at a molar ratio of 5:10.4:15 and the mixture was applied with ultrasonic waves for 5 minutes and then dried to prepare a cathode active material for lithium secondary battery.

The prepared cathode active material for lithium secondary battery was heat-treated at 800° C. for 10 hours under air atmosphere.

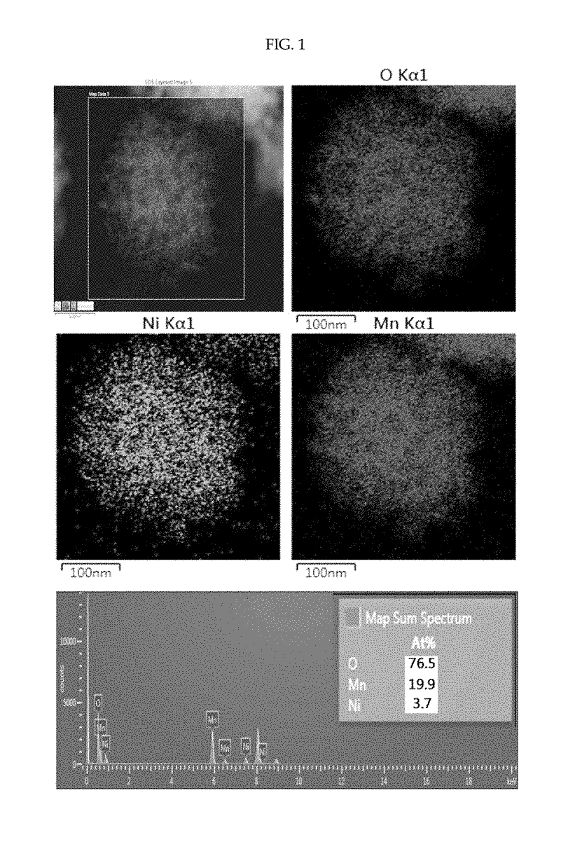

FIG. 1 illustrates the distribution of metals contained in the cathode active material prepared in Example 1 using EDS. EDS stands for Energy Dispersive Spectrometer and refers to a device for direct observation of the distribution of atoms contained in a sample.

FIG. 1 illustrates the distribution of constituent elements of the cathode active material as the basis of EDS analysis. It can be seen from FIG. 1 that nickel, manganese, and oxygen are evenly distributed in the prepared cathode active material for lithium secondary battery.

### Comparative Example 1

A cathode active material was manufactured in the same manner as described in Example 1 except that Ni(NO₃)₂·6H₂O and LiOH were excluded and LiI was used instead of LiOH.

### Fabrication of Coin Cell

Batteries were fabricated by the following method in order to evaluate electrochemical properties of secondary batteries including the cathode active materials prepared in Example 1 and Comparative Example 1, respectively.

A 70 wt % cathode active material, 15 wt % conductive activated carbon, and a 15 wt % polyvinyl difluoride binder were mixed with NMP (N-methyl-2-pyrrolidine) to prepare slurry. The slurry was applied to aluminum foil and then dried and rolled to prepare a cathode. The cathode, lithium metal, and a separator were used to fabricate a coin cell. Herein, a solution including 1.0 M LiPF₆ dissolved in a 1:1-mixed solution of ethylene carbonate (EC) and dimethyl carbonate (DMC) was used as an electrolyte.

### Evaluation Result

### 1. Transmission Electron Microscopic Image

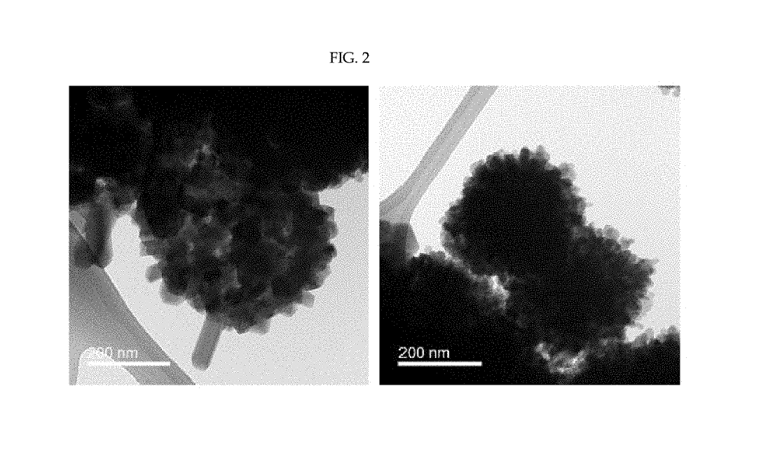

The shape of the cathode active material for lithium secondary battery manufactured in Example 1 of the present disclosure was observed with a transmission electron microscope (TEM) and the result was as illustrated in FIG. 2.

It can be seen from FIG. 2 that the cathode active material for lithium secondary battery manufactured in Example 1 included crystalline rod particles laminated into a spherical shape and had a mesoporous surface.

### 2. Characteristics of Battery

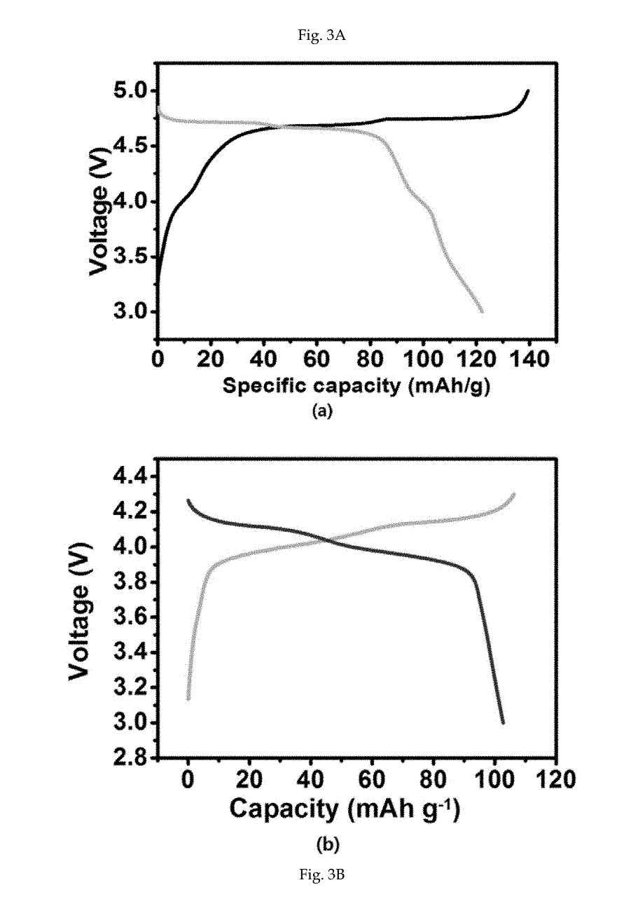

In order to analyze battery properties of a battery including the cathode active materials prepared in Example 1 and Comparative Example 1, respectively, initial charge and discharge characteristics were evaluated by performing a charge and a discharge of 0.1 C at a charge/discharge potential of from 3.0 V to 4.3 V and the result was as illustrated in FIG. 3A and FIG. 3B.

The charge/discharge curves show that a voltage of the battery including the cathode active materials prepared in Example 1 as illustrated in FIG. 3A was higher than that of the battery including the cathode active materials prepared in Comparative Example 1 as illustrated in FIG. 3B. Further, as a result of comparison between the batteries in discharge capacity after 100 charge and discharge cycles, the battery of FIG. 3A was 140 mAh/g or more and the battery of FIG. 3B was nearly 110 mAh/g.

This means that its mesoporous structure maximizes the reaction area and thus enables lithium ions to be easily moved and its stable structure with a high crystallinity suppresses elution of Mn³⁺ from a crystal structure, and, thus, if the cathode active material is applied to a secondary battery, the cycle and lifespan characteristics of the secondary battery can be improved.

What is claimed is:

1. A manufacturing method of a cathode active material for lithium secondary battery, the method comprising:
mixing a metal oxide and a solvent to prepare a first solution;
adding an acidic solution to the first solution and then applying ultrasonic waves to the mixture to prepare a metal-mixed solution;
centrifuging the metal-mixed solution;
mixing a supernatant of the centrifuged metal-mixed solution, a reductant, and a solvent and then applying ultrasonic waves to the mixture to prepare a second solution;
filtering and then drying the second solution to obtain powder;
mixing the powder, a metal, a lithium precursor, and a solvent, applying ultrasonic waves to the mixture and then drying the mixture to form mesoporous spherical nanoparticles; and
performing a heat treatment to the spherical nanoparticles.

2. The manufacturing method of a cathode active material for lithium secondary battery according to claim 1, wherein in the preparing of the metal-mixed solution, the preparing of the second solution, and the forming of the mesoporous spherical nanoparticles, ultrasonic waves with a frequency in the range of from 5 kHz to 50 kHz are applied for 1 minute to 60 minutes.

3. The manufacturing method of a cathode active material for lithium secondary battery according to claim 1, wherein the preparing of the metal-mixed solution, the preparing of the second solution, and the forming of the mesoporous spherical nanoparticles are performed at a temperature in the range of from 10° C. to 40° C.

4. The manufacturing method of a cathode active material for lithium secondary battery according to claim 1, wherein the heat treatment is performed in the range of from 600° C. to 900° C.

5. The manufacturing method of a cathode active material for lithium secondary battery according to claim 1, wherein the acidic solution includes at least one acid selected from the group consisting of sulfuric acid (H₂SO₄), hydrochloric acid (HCl), phosphoric acid (H₃PO₄), acetic acid (CH₃COOH), and nitric acid (HNO₃).

6. The manufacturing method of a cathode active material for lithium secondary battery according to claim 1, wherein the metal oxide includes a metal oxide based on at least one metal selected from the group consisting of Li, B, C, Na, Mg, Al, Si, P, Ca, Sc, Ti, V, Cr, Mn, Fe, Co, Ni, Cu, Zn, Ga, Ge, As, Sr, Y, Zr, Nb, Mo, Sn, Ba, Hf, and La.

7. The manufacturing method of a cathode active material for lithium secondary battery according to claim 1, wherein the solvent includes at least one solvent selected from the group consisting of ethanol, anhydrous ethanol, isopropyl alcohol, or combinations thereof.

8. The manufacturing method of a cathode active material for lithium secondary battery according to claim 1, wherein the reductant is manganese sulfate (MnSO₄) or manganese chloride (MnCl₂).

9. A cathode active material for lithium secondary battery which includes at least one compound selected from general formula (1) below and has a mesoporous spherical nanoparticle shape:
Li₁₊ₓMn_{2-y}M_{y}O₄ (1)
wherein in general formula (1), M is at least one metal selected from the group consisting of Ni, Co, Mn, Al, V, Fe, P, and Cr, 0≤x≤0.1, and 0.3≤y≤0.7.

10. A lithium secondary battery comprising:
the cathode active material of claim 1;
an anode active material; and
an electrolyte.
